(19) United States
(12) Patent Application Publication
(10) Pub. No.: US 2021/0398071 A1
(43) Pub. Date: Dec. 23, 2021

(54) LOGISTICS SUPPORTING DEVICE

(71) Applicant: TOYOTA JIDOSHA KABUSHIKI KAISHA, Aichi-ken (JP)

(72) Inventors: Seigo KUZUMAKI, Toyota-shi (JP); Takashi HAYASHI, Toyota-shi (JP)

(21) Appl. No.: 17/348,766

(22) Filed: Jun. 16, 2021

(30) Foreign Application Priority Data
Jun. 18, 2020 (JP) 2020-105419

(51) Int. Cl. G06Q 10/08

(52) U.S. Cl. CPC G06Q 10/0835; G06Q 10/0838

(57) ABSTRACT

A logistics supporting device includes: a processor, wherein the processor is configured to: acquire, from a plurality of carriers, load situations of respective delivery centers that are retained by the respective carriers; and based on acquired load situations of the respective delivery centers, carry out at least one of delivery area changing processing, which changes delivery areas such that a delivery area of a delivery center that has a small load becomes larger, or resource supplementing processing that supplements resources of a delivery center that has a large load.

### CROSS-REFERENCE TO RELATED APPLICATION

This application is based on and claims priority under 35 USC 119 from Japanese Patent Application No. 2020-105419 filed on Jun. 18, 2020, the disclosure of which is incorporated by reference herein.

### BACKGROUND

### Technical Field

The present invention relates to a logistics supporting device.

### Related Art

Japanese Patent Application Laid-Open (JP-A) No. 2003-12156 discloses a cooperative logistics supporting system that uses the internet. In this cooperative logistics supporting system, while applications with respect to proposals for cooperative transport/delivery of freight are received by a web server from shippers via the internet, bids are received from carriers via the internet. The bidding states are provided on the internet, and orders from shippers are received via the internet.

However, in the cooperative logistics supporting system disclosed in JP-A No. 2003-12156, because it is the shipper who ultimately selects the carrier, there is room for improvement from the standpoint of equalizing the loads on the delivery centers that the respective carriers retain.

### SUMMARY

The present disclosure provides a logistics supporting device that may suppress load being unduly concentrated at a delivery center that is retained by a carrier.

A first aspect of the present disclosure is a logistics supporting device including: a load information acquiring section that acquires, from a plurality of carriers, load situations of respective delivery centers that are retained by the respective carriers; and a data changing section that, based on the load situations of the respective delivery centers acquired by the load information acquiring section, carries out at least one of delivery area changing processing, which changes delivery areas such that a delivery area of a delivery center that has a small load becomes larger, or resource supplementing processing that supplements resources of a delivery center that has a large load.

In the logistics supporting device of the first aspect, the load situations of respective delivery centers that are retained by respective carriers are acquired by the load information acquiring section. Further, based on the load situations of the respective delivery centers, the data changing section carries out at least one of delivery area changing processing or resource supplementing processing. Here, in the delivery area changing processing, the delivery areas are changed such that the delivery area of a delivery center that has a small load becomes larger. Due thereto, the delivery area of a delivery center that has a large load may be reduced relatively.

Further, in the resource supplementing processing, the resources of a delivery center that has a large load are supplemented. Due thereto, the load on a delivery center that has a large load can be reduced. Note that what is called resources here is a concept that broadly encompasses the number of delivery workers and number of delivery vehicles of a delivery center, and sorting workers who carry out sorting of freight within the delivery center, and the like.

In a second aspect of the present disclosure, in the first aspect, the resource supplementing processing may increase a number of workers of the delivery center that has a large load, by changing information of the delivery centers with which workers are affiliated.

In the logistics supporting device of the second aspect, by increasing the number of workers of a delivery center that has a large load, the load per worker at that delivery center may be reduced.

In a third aspect of the present disclosure, in the first aspect or the second aspect, the resource supplementing processing may increase a number of vehicles that are used at the delivery center that has a large load, by changing information of vehicles retained by the respective delivery centers.

In the logistics supporting device relating to the third aspect of the present disclosure, because the number of vehicles that may be used at a delivery center that has a large load is increased, the number of freight that may be delivered at one time may be increased.

In a fourth aspect of the present disclosure, any one of the first through the third aspects, may further include: a predicting section that predicts changes in the load situations at the respective delivery centers, wherein the data changing section carries out at least one of the delivery area changing processing or the resource supplementing processing based on the load situations of the respective delivery centers acquired by the load information acquiring section and changes in the load situations predicted by the predicting section.

In the logistics supporting device of the fourth aspect of the present disclosure, due to the predicting section predicting changes in the load situations, changing of the delivery areas, supplementing of resources, and the like may be carried out before the load becomes large.

In a fifth aspect of the present disclosure, any one of the first through the fourth aspects, may further include: a change request receiving section that receives, from shippers and delivery destinations, change requests including receiving date and time changes and receiving method changes; and a notification section that notifies the respective delivery centers of contents of change requests received by the change request receiving section.

In the logistics supporting device of the fifth aspect, the notification section notifies the respective delivery centers of change requests that are received by the change request receiving section. Due thereto, change requests may be shared between plural carriers and can be handled rapidly.

As described above, in accordance with the logistics supporting device relating to the present disclosure, load being unduly concentrated at a delivery center that is retained by a carrier can be suppressed.

### BRIEF DESCRIPTION OF THE DRAWINGS

Exemplary embodiments of the present disclosure will be described in detail based on the following figures, wherein:

FIG. 1 is a schematic drawing illustrating the overall structure of a logistics system that includes a logistics supporting device relating to a first exemplary embodiment;

FIG. 2 is a schematic drawing that corresponds to FIG. 1 and illustrates a state in which delivery areas have changed;

FIG. 3 is a block drawing illustrating hardware structures of a logistics supporting device relating to the first exemplary embodiment;

FIG. 4 is a block drawing illustrating functional structures of the logistics supporting device relating to the first exemplary embodiment;

FIG. 5 is a flowchart illustrating an example of the flow of logistics supporting processing relating to the first exemplary embodiment;

FIG. 6 is a block drawing illustrating functional structures of a logistics supporting device relating to a second exemplary embodiment; and

FIG. 7 is a flowchart illustrating an example of the flow of logistics supporting processing relating to the second exemplary embodiment.

### DETAILED DESCRIPTION

### First Exemplary Embodiment

A logistics supporting system 11 that includes a logistics supporting device 10 relating to a first exemplary embodiment is described with reference to the drawings.

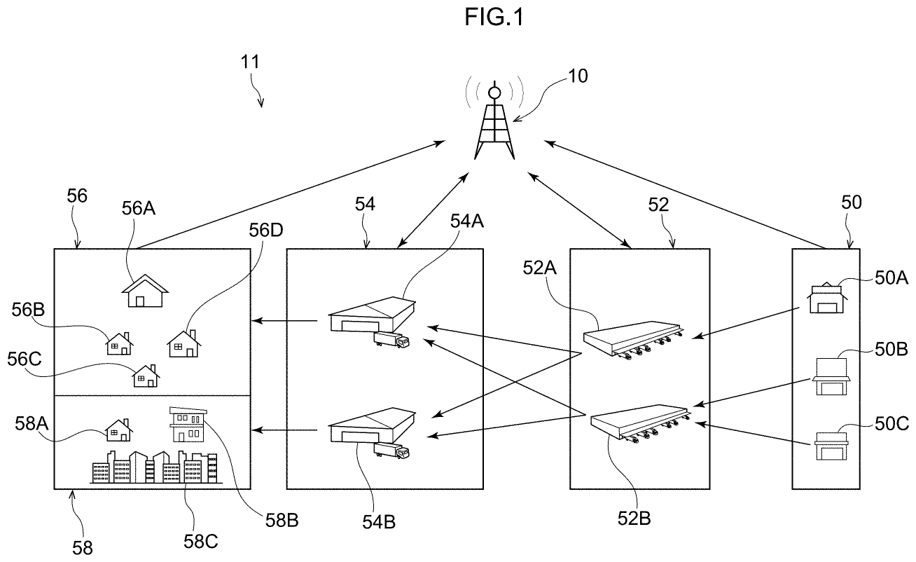

As illustrated in FIG. 1, the logistics supporting system 11 of the present exemplary embodiment includes the logistics supporting device 10. The logistics supporting device 10 is, via networks, connected to a shipper group 50, a collection center group 52, a delivery center group 54, a first delivery destination group 56, and a second delivery destination group 58.

Plural shippers are included in the shipper group 50, and shipper 50A, shipper 50B and shipper 50C are illustrated as an example in FIG. 1. The shipper 50A, the shipper 50B and the shipper 50C directly or indirectly receive orders from consumers and the like, and package goods and the like, and request carriers to deliver the goods and the like.

Plural collection centers are included in the collection center group 52, and collection center 52A and collection center 52B are illustrated as an example in FIG. 1. Here, the collection center 52A and the collection center 52B are collection centers that are retained by different carriers. Therefore, movement of freight is not carried out between the collection center 52A and the collection center 52B. Further, in FIG. 1, freight that is shipped from the shipper 50A is collected at the collection center 52A, and freight that is shipped from the shipper 50B and the shipper 50C is collected at the collection center 52B.

Plural delivery centers are included in the delivery center group 54, and delivery center 54A and delivery center 54B are illustrated as an example in FIG. 1. The delivery center 54A is retained by the same carrier as the collection center 52A, and the delivery center 54B is retained by the same carrier as the collection center 52B.

Here, in the present exemplary embodiment, a system in which the carrier of the delivery center 54A and the carrier of the delivery center 54B carry out cooperative delivery is constructed. Namely, for freight having a shared delivery area of delivery destinations, due to the carriers carrying out delivery cooperatively, the number of vehicles that are needed for delivery is reduced. In FIG. 1, the delivery area of the delivery center 54A is set to delivery destination 56A through delivery destination 56D that belong to the first delivery destination group 56. The delivery area of the delivery center 54B is set to delivery destination 58A through delivery destination 58C that belong to the second delivery destination group 58. Note that the delivery destination 56A through the delivery destination 56D are representatives of the first delivery destination group 56, and, in reality, many other delivery destinations belong to the first delivery destination group 56. Similarly, the delivery destination 58A through the delivery destination 58C are representatives of the second delivery destination group 58, and, in reality, many other delivery destinations belong to the second delivery destination group 58.

In this way, freight is delivered from the collection center 52A and the collection center 52B to the delivery center 54A or the delivery center 54B in accordance with the delivery area. Namely, in cooperative delivery, there are cases in which freight is sent from the collection center 52A to the delivery center 54B that is retained by another carrier. Similarly, there are cases in which freight is sent from the collection center 52B to the delivery center 54A that is retained by another carrier.

Here, the delivery destination 58C is a relatively newly built, multiple-dwelling complex, and the freight situation varies depending on the construction of the delivery destination 58C. In FIG. 1, due to the delivery destination 58C being built, the number of delivery destinations of the delivery center 54B becomes large all at once, and a state in which the load on the delivery center 54B is large is illustrated.

(Hardware Structures of Logistics Supporting Device 10)

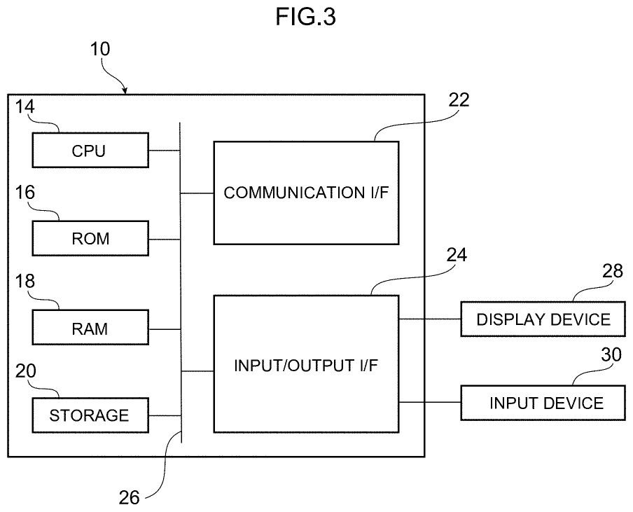

As illustrated in FIG. 3, the logistics supporting device 10 of the present exemplary embodiment is structured to include a CPU (Central Processing Unit: processor) 14, a ROM (Read Only Memory) 16, a RAM (Random Access Memory) 18, a storage 20, a communication interface 22 and an input/output interface 24. These respective structures are connected so as to be able to communicate with one another via a bus 26.

The CPU 14 is a central computing processing unit, and executes various programs and controls various sections. Namely, the CPU 14 reads-out programs from the ROM 16 or the storage 20, and executes the programs by using the RAM 18 as a workspace. The CPU 14 carries out control of the above-described respective structures and various computing processings in accordance with programs that are recorded in the ROM 16 or the storage 20.

The ROM 16 stores various programs and various data. The RAM 18 temporarily stores programs and data as a workspace. The storage 20 is structured by an HDD (Hard Disk Drive) or an SSD (Solid State Drive), and is a non-transitory recording medium that stores various programs including the operating system, and various data. In the present exemplary embodiment, a logistics support program and the like are stored in the ROM 16 or the storage 20.

The communication interface 22 is an interface for enabling the logistics supporting device 10 to communicate by a computer network, and uses standards such as for example, 5G, LTE, Ethernet® or the like.

A display device 28 and an input device 30 are connected to the input/output interface 24. The display device 28 is a display or the like that are for the manager of the logistics supporting device 10 to see information. The input device 30 is a keyboard and a mouse and the like that are for the manager to carry out input to the logistics supporting device 10.

(Functional Structures of Logistics Supporting Device 10)

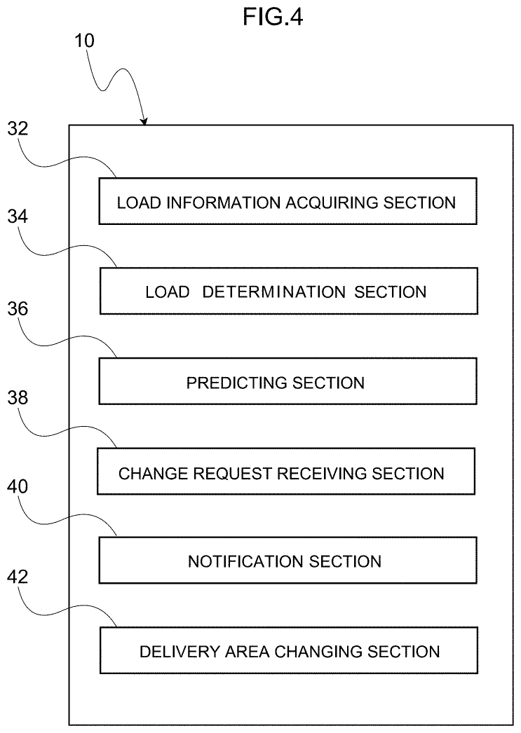

The logistics supporting device 10 realizes various functions by using the above-described hardware resources. The functional structures that are realized by the logistics supporting device 10 are described with reference to FIG. 4.

As illustrated in FIG. 4, the logistics supporting device 10 is structured to include, as the functional structures thereof, a load information acquiring section 32, a load determination section 34, a predicting section 36, a change request receiving section 38, a notification section 40, and a delivery area changing section 42 that serves as a data changing section. These respective functional structures are realized by the CPU 14 reading-out and executing a program that is stored in the ROM 16 or the storage 20.

The load information acquiring section 32 acquires, from plural carriers, information relating to the load situations of the delivery centers retained by the respective carriers. Concretely, the load information acquiring section 32 acquires, by the communication interface 22, information relating to the load situations of the plural delivery centers that structure the delivery center group 54. In the present exemplary embodiment, as an example, the load information acquiring section 32 acquires information relating to the load situations of the delivery center 54A and the delivery center 54B. Information relating to the load situation is information that includes the number of scheduled freight deliveries, the number of workers, the number of vehicles, the sizes of the vehicles, and the like.

The load determination section 34 determinates the extent of the load at each delivery center based on the information relating to the load situations of the delivery center 54A and the delivery center 54B that was acquired by the load information acquiring section 32. For example, the load determination section 34 determinates that the load is large in a case in which the number of scheduled freight deliveries with respect to the number of workers is greater than a predetermined upper limit value, and in a case in which the number of vehicles with respect to the number of scheduled freight deliveries is less than a predetermined lower limit value. Further, for example, the load determination section 34 determinates that the load is small in a case in which the number of scheduled freight deliveries with respect to the number of workers is less than a predetermined lower limit value, and in a case in which the number of vehicles with respect to the number of scheduled freight deliveries is greater than a predetermined upper limit value.

The predicting section 36 predicts changes in the load situations at the plural delivery centers that structure the delivery center group 54. For example, the predicting section 36 acquires information relating to the numbers of the freight collected at the collection center 52A and the collection center 52B and the delivery destinations thereof, and, on the basis of the acquired information, predicts changes in the load situations of the delivery center 54A and the delivery center 54B. Namely, on the basis of information that is the number of freight collected at the collection center 52A and the delivery destinations of the freight, if the number of freight that are scheduled to be sent from the collection center 52A to the delivery center 54B is greater than a predetermined number, the predicting section 36 predicts that the load on the delivery center 54B will become large.

Further, the predicting section 36 may acquire information of the freight scheduled for delivery that is acquired from the shipper group 50, and, on the basis of the acquired information, may predict changes in the load situations of the delivery center 54A and the delivery center 54B. For example, in a case in which the delivery destinations of freight scheduled for delivery, which information is acquired from the shipper group 50, are concentrated in the delivery area of the second delivery destination group 58, the predicting section 36 predicts that the load on the delivery center 54B will become large.

The change request receiving section 38 receives requests for changes, which include receiving date/time changes and receiving method changes, from the shipper group 50, the first delivery destination group 56 and the second delivery destination group 58. The receiving dates/times of the shipper group 50 are the desired dates/times for collecting the freight. The receiving dates/times of the first delivery destination group 56 and the second delivery destination group 58 are the desired dates/times for delivering the freight. The receiving date/time change requests and the receiving method change requests are acquired by communication with the shipper group 50, the first delivery destination group 56 and the second delivery destination group 58 by the communication interface 22.

The notification section 40 notifies the delivery center 54A and the delivery center 54B of the contents of the change requests received by the change request receiving section 38. The notification section 40 may similarly notify the collection center 52A and the collection center 52B as well of the contents of the change requests.

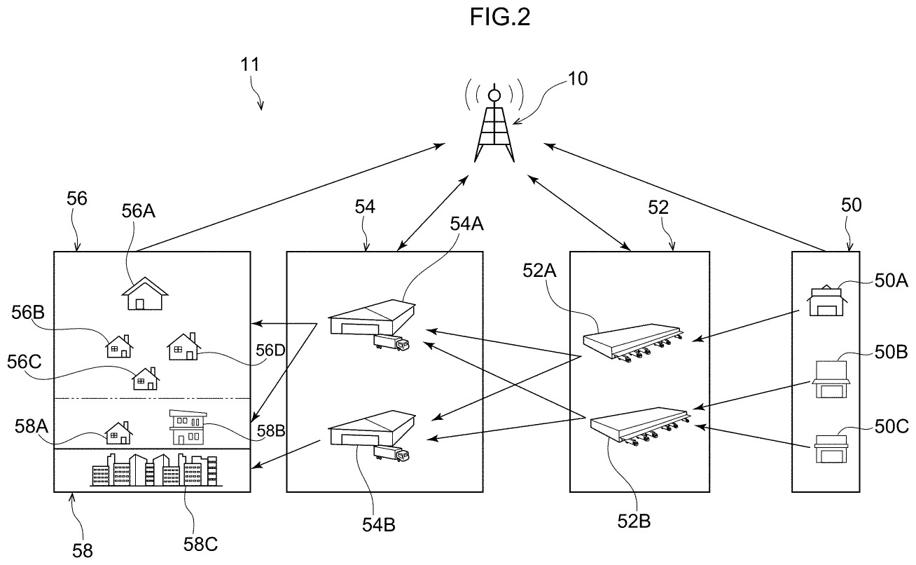

The delivery area changing section 42 carries out delivery area changing processing that changes the delivery areas such that the delivery area of a delivery center whose load is small is enlarged. Concretely, the delivery area changing section 42 changes the delivery areas on the basis of the load situations of the delivery center 54A and the delivery center 54B that were acquired by the load information acquiring section 32, and the changes in the load situations of the delivery center 54A and the delivery center 54B that were predicted by the predicting section 36. The concrete method of changing the delivery areas is described hereinafter with reference to FIG. 1 and FIG. 2.

As illustrated in FIG. 1, a case can be envisaged in which, due to the delivery destination 58C which is a multiple-dwelling complex being built in the second delivery destination group 58, there is a large number of freight that are to be delivered to the second delivery destination group 58. In this case, on the basis of the information that the load information acquiring section 32 acquired from the delivery center 54B, the load determination section 34 determinates that the load on the delivery center 54B has become large. Further, the predicting section 36 predicts that the load on the delivery center 54B will become large from the information relating to the numbers of and the delivery destinations of the freight that are collected at the collection center 52A and the collection center 52B. In this case, the delivery area changing section 42 changes some of the delivery destinations that belong to the second delivery destination group 58 to the delivery area of the first delivery destination group 56.

As illustrated in FIG. 2, as an example, the delivery area changing section 42 of the present exemplary embodiment changes the delivery destination 58A and the delivery destination 58B to delivery areas of the first delivery destination group 56. Concretely, the addresses of the delivery destination 58A and the delivery destination 58B are added to the delivery area that the delivery center 54A is responsible for and that is registered in a database. Further, the addresses of the delivery destination 58A and the delivery destination 58B are removed from the delivery area that the delivery center 54B is responsible for and that is registered in the database.

Here, the delivery destinations of the freight, which are delivered from the collection center 52A and the collection center 52B to the delivery center 54A and the delivery center 54B, are decided upon on the basis of the delivery areas that are registered in the database. Therefore, due to the delivery areas being changed by the delivery area changing section 42, the freight that are to be delivered to the delivery destination 58A and the delivery destination 58B are delivered from the collection center 52A and the collection center 52B to the delivery center 54A.

(Operation)

Operation of the present exemplary embodiment is described next.

### Example of Logistics Supporting Processing

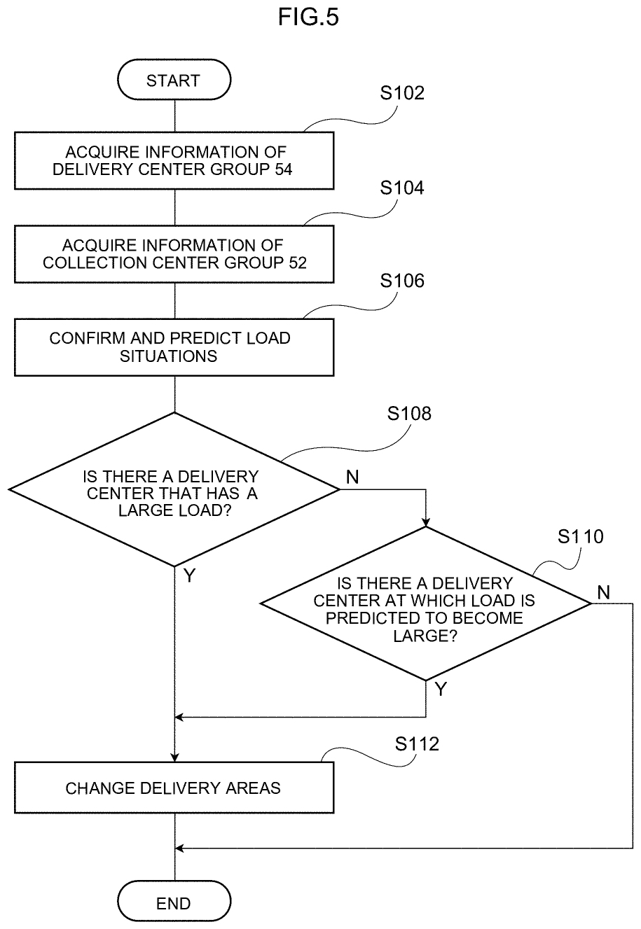

FIG. 5 is a flowchart illustrating an example of the flow of the logistics supporting processing by the logistics supporting device 10. This logistics supporting processing is executed due to the CPU 14 reading-out a program from the ROM 16 or the storage 20, and expanding and executing the program in the RAM 18. Further, in the present exemplary embodiment, as an example, the logistics supporting processing is executed at a period which is of an extent such that changing of the delivery areas is not carried out frequently.

As illustrated in FIG. 5, in step S102, the CPU 14 acquires information of the delivery center group 54. Concretely, by the function of the load information acquiring section 32, the CPU 14 acquires information relating to the load situations of the plural delivery centers that structure the delivery center group 54.

Next, in step S104, the CPU 14 acquires information of the collection center group 52. Concretely, the CPU 14 acquires the number of and the delivery destinations of the freight that are collected at the collection center 52A and the collection center 52B that structure the collection center group 52.

In step S106, the CPU 14 carries out confirmation of the load situations, and prediction of changes in the load situations. Concretely, by the function of the load determination section 34, the CPU 14 confirms the absence/presence of a delivery center having a large load, on the basis of the information relating to the load situations of the delivery center group 54 that was acquired in step S102.

Further, in step S106, by the function of the predicting section 36, the CPU 14 confirms the absence/presence of a delivery center at which it is predicted that the load will become large, on the basis of the numbers of and the delivery destinations of the freight collected at the collection center group 52, which information was acquired in step S104.

Next, in step S108, the CPU 14 determinates whether or not there is a delivery center that has a large load. If there is a delivery center that has a large load, the CPU 14 moves on to the processing of step S112. For example, for each of the delivery center 54A and the delivery center 54B, in a case in which the number of freight per delivery worker, and the number of freight per delivery vehicle, exceed predetermined upper limit values, it may be judged that the load is large. On the other hand, if there is no center that has a large load in step S108, the CPU 14 moves on to the processing of step S110.

In step S110, the CPU 14 determinates whether or not there is a delivery center at which it is predicted that the load will become large. If there is a delivery center at which it is predicted that the load will become large, the CPU 14 moves on to the processing of step S112. For example, from the information of the numbers of the freight collected at the collection center 52A and the collection center 52B and the delivery destinations thereof, it may be predicted the load will become large in a case in which the number of freight that are to be delivered to the delivery center 54A or the delivery center 54B is greater than a predetermined upper limit value. On the other hand, if there is no delivery center at which it is predicted that the load will become large in step S110, the CPU 14 ends the logistics supporting processing.

If the CPU 14 determinates in step S108 that there is a delivery center that has a large load, or if the CPU 14 determinates in step S110 that there is a delivery center at which it is predicted that the load will become large, the CPU 14 moves on to the processing of step S112 and changes the delivery areas. Concretely, by the function of the delivery area changing section 42, the CPU 14 changes the delivery areas such that the delivery area of the delivery center whose load is small becomes larger, and, due thereto, the delivery area of the delivery center whose load is large becomes smaller. For example, by changing the delivery areas from the state of FIG. 1 to the state of FIG. 2, the delivery area of the second delivery destination group 58 becomes smaller, and the number of delivery destinations that the delivery center 54B is responsible for is reduced. Then, the CPU 14 ends the logistics supporting processing.

As described above, at the logistics supporting device 10 relating to the present exemplary embodiment, on the basis of the load situations of the delivery center 54A and the delivery center 54B that structure the delivery center group 54, the delivery area changing section 42 that serves as the data changing section changes the delivery areas such that the delivery area of the delivery center whose load is small becomes larger. Due thereto, the delivery area of the delivery center whose load is large can be reduced, and the load being unduly concentrated at a delivery center that the shipper retains can be suppressed.

Further, at the logistics supporting device 10 of the present exemplary embodiment, due to the predicting section 36 predicting changes in the load situations, changing of the delivery areas and supplementing of resources and the like can be carried out before the load becomes large.

Moreover, at the logistics supporting device 10 of the present exemplary embodiment, the notification section 40 notifies the respective delivery centers of the change requests received by the change request receiving section 38. Due thereto, change requests can be shared between plural carriers, and situations can be handled rapidly.

### Second Exemplary Embodiment

A logistics supporting device 60 relating to a second exemplary embodiment is described next. Note that structures that are similar to those of the first exemplary embodiment are denoted by the same reference numerals, and description thereof is omitted as appropriate. Further, the overall structure of the logistics supporting system 11 is similar to that of the first exemplary embodiment illustrated in FIG. 1.

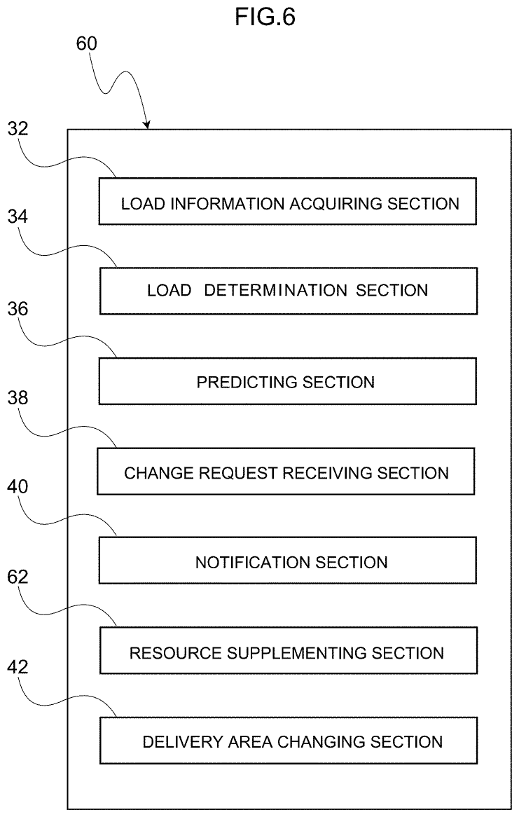

As illustrated in FIG. 6, the logistics supporting device 60 relating to the present exemplary embodiment differs from the first exemplary embodiment with regard to the point that the logistics supporting device 60 has a resource supplementing section 62 as a functional structure. Here, the delivery area changing section 42 and the resource supplementing section 62 correspond to the data changing section of the present disclosure.

The resource supplementing section 62 supplements the resources of a delivery center whose load is large. Concretely, the resource supplementing section 62 supplements the resources of a delivery center whose load is large on the basis of the load situations of the delivery center 54A and the delivery center 54B that are acquired from the load information acquiring section 32, and changes in the load situations of the delivery center 54A and the delivery center 54B that are predicted by the predicting section 36.

For example, in the state of FIG. 1, in a case in which the load on the delivery center 54B is large, the resource supplementing section 62 carries out processing to increase the number of workers at the delivery center 54B where the load is large, by changing the information of the delivery centers with which workers are affiliated. Further, the resource supplementing section 62 may carry out processing to increase the number of vehicles that are used at the delivery center 54B where the load is large, by changing the information of the vehicles that each delivery center has. Namely, by changing the information of the workers and the vehicles of the delivery center 54A, workers and vehicles are relegated from the delivery center 54A to the delivery center 54B, and the numbers of workers and vehicles of the delivery center 54B increase.

(Operation)

Operation of the present exemplary embodiment is described next.

### Example of Logistics Supporting Processing

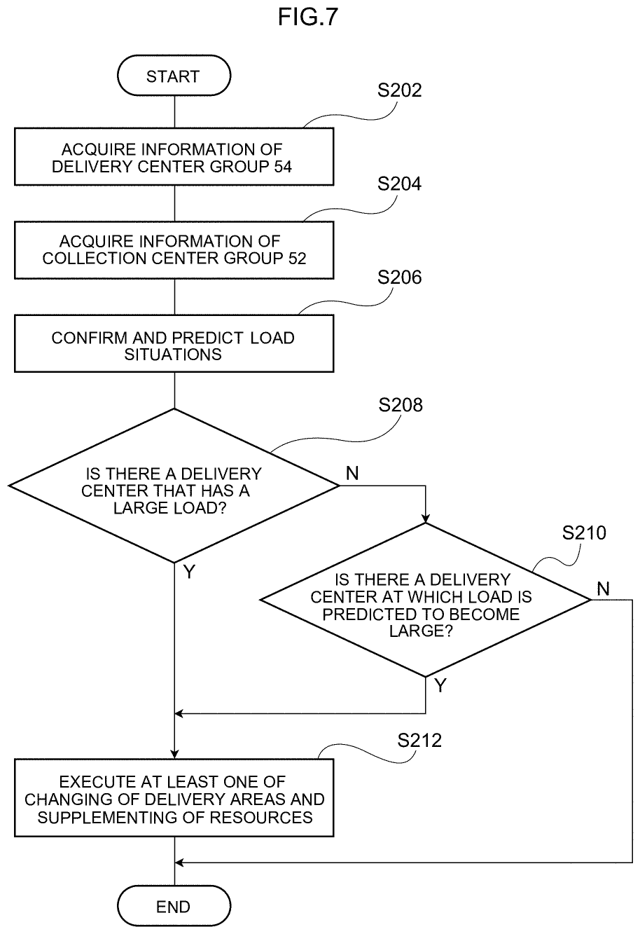

FIG. 7 is a flowchart illustrating an example of the flow of the logistics supporting processing by the logistics supporting device 60. This logistics supporting processing is executed due to the CPU 14 reading-out a program from the ROM 16 or the storage 20, and expanding and executing the program in the RAM 18. Further, in the present exemplary embodiment, as an example, the logistics supporting processing is executed at a fixed period.

As illustrated in FIG. 7, the processings from step S202 to step S210 are the same as the processings from step S102 to step S110 of the logistics supporting processing of the first exemplary embodiment illustrated in FIG. 5, and therefore, description thereof is omitted.

If the CPU 14 determinates that there is a delivery center that has a large load in step S208, or if the CPU 14 determinates that there is a delivery center at which it is predicted that the load will become large in step S210, the CPU 14 moves on to the processing of step S212.

In step S212, the CPU 14 executes at least one of changing of the delivery areas and supplementing of resources. Concretely, in the state of FIG. 1, if it is judged that the load on the delivery center 54B is large, or if it is predicted that the load on the delivery center 54B will become large, the CPU 14 executes at least one of changing of the delivery areas and supplementing of resources.

In step S212, when the CPU 14 carries out changing of the delivery areas, the CPU 14 changes the delivery areas to the state of FIG. 2 by the function of the delivery area changing section 42. Due thereto, the delivery area of the second delivery destination group 58 becomes smaller, and the number of delivery destinations of the delivery center 54B is decreased.

On the other hand, in step S212, when the CPU 14 carries out supplementing of resources, the CPU 14 carries out at least one of increasing the number of workers and increasing the number of vehicles of the delivery center 54B at which the load is large, by the function of the resource supplementing section 62.

Here, in the present exemplary embodiment, in step S212, both changing of the delivery areas and supplementing of resources may be carried out, or one only may be carried out. For example, in a case in which the load on the delivery center 54B becomes markedly large, both changing of the delivery areas and supplementing of resources are executed. Further, in a case in which the loads are equalized by carrying out only one of changing of the delivery areas and supplementing of resources, which of the changing of the delivery areas and the supplementing of resources is to be executed may be judged after confirming the resources of the delivery center 54A and the delivery center 54B. For example, in a case in which the numbers of workers and vehicles at the delivery center 54A are low, it is difficult to supplement workers from the delivery center 54A to the delivery center 54B, and therefore, changing of the delivery areas only may be executed.

As described above, in the logistics supporting device 60 of the present exemplary embodiment, by supplementing the resources at a delivery center where the load is large by the resource supplementing section 62, the load on a delivery center that has a large load can be reduced.

In particular, due to the resource supplementing section 62 increasing the number of workers at a delivery center where the load is large, the load per worker at the delivery center can be reduced. Further, due to the resource supplementing section 62 increasing the number of vehicles that can be used at a delivery center where the load is large, the number of freight that can be delivered at one time can be increased.

Further, in the logistics supporting device 60 of the present exemplary embodiment, the judgement as to which of changing of the delivery areas and supplementing of resources is to be executed is carried out after confirming the resources of the delivery center 54A and the delivery center 54B. Due thereto, equalization of the loads can be carried out more effectively. The other operations are similar to those of the first exemplary embodiment.

The logistics supporting devices 10, 60 relating to exemplary embodiments have been described above, but the present disclosure can, of course, be implemented in various forms within a scope that does not depart from the gist thereof. For example, in the above-described exemplary embodiments, as illustrated in FIG. 1, freight is collected at the collection center 52A and the collection center 52B from the respective shippers of the shipper group 50, and thereafter, the freight are delivered to the delivery center 54A and the delivery center 54B. However, the present disclosure is not limited to this. Namely, there may be a structure in which freight is delivered directly to the delivery center 54A and the delivery center 54B from the respective shippers of the shipper group 50. Further, freight that is to be shipped from a shipper may be temporarily held at a holding place that respective carriers use in common, or the like, and the freight may be delivered from this temporary holding place to the delivery center group 54.

Moreover, the above-described second exemplary embodiment describes, as an example, a structure in which workers and vehicles and the like are supplemented from the delivery center 54A to the delivery center 54B by the function of the resource supplementing section 62. However, the present disclosure is not limited to this. For example, there may be a structure in which workers and vehicles that are not affiliated with any of the carriers are administered by the respective carriers, and these resources are allocated to a delivery center at which the load is large. In this case, the resources of another delivery center decreasing can be suppressed.

Moreover, although the above-described second exemplary embodiment describes a structure in which workers and vehicles that carry out delivery are supplemented by the resource supplementing section 62, the present disclosure is not limited to this. For example, workers who sort freight may be supplemented by the resource supplementing section 62. Further, resources may be supplemented by the vehicles being changed to large delivery vehicles by the resource supplementing section 62.

Still further, any of various types of processors other than a CPU may execute the processings that the CPU 14 executes by reading software (programs) in the above-described exemplary embodiments. Examples of processors in this case include PLDs (Programmable Logic Devices) whose circuit structure can be changed after production such as FPGAs (Field-Programmable Gate Arrays) and the like, or dedicated electrical circuits that are processors having circuit structures that are designed for the sole purpose of executing specific processings such as ASICs (Application Specific Integrated Circuits) and the like, or the like. Further, the logistics supporting processing may be executed by one of these various types of processors, or may be executed by combining two or more of the same type or different types of processors (e.g., plural FPGAs, or a combination of a CPU and an FPGA, or the like). Further, the hardware structures of these various types of processors are, more concretely, electrical circuits that combine circuit elements such as semiconductor elements and the like.

Moreover, although the storage 20 is used as the recording section in the above-described exemplary embodiments, the present disclosure is not limited to this. For example, a non-transitory recording medium such as a CD (Compact Disk), a DVD (Digital Versatile Disk), a USB (Universal Serial Bus) memory, or the like may be used as the recording section. In this case, various types of programs may be stored on these recording media.

What is claimed is:

1. A logistics supporting device comprising:
a processor,
wherein the processor is configured to:
acquire, from a plurality of carriers, load situations of respective delivery centers that are retained by the respective carriers; and
based on acquired load situations of the respective delivery centers, carry out at least one of delivery area changing processing, which changes delivery areas such that a delivery area of a delivery center that has a small load becomes larger, or resource supplementing processing that supplements resources of a delivery center that has a large load.

2. The logistics supporting device of claim 1, wherein the processor increases a number of workers of the delivery center that has a large load, by changing information of the delivery centers with which workers are affiliated.

3. The logistics supporting device of claim 1, wherein the processor increases a number of vehicles that are used at the delivery center that has a large load, by changing information of vehicles retained by the respective delivery centers.

4. The logistics supporting device of claim 1, wherein the processor:
predicts changes in the load situations at the respective delivery centers, and
carries out at least one of the delivery area changing processing or the resource supplementing processing based on acquired load situations of the respective delivery centers and predicted changes in the load situations.

5. The logistics supporting device of claim 1, wherein the processor:
receives, from shippers and delivery destinations, change requests including receiving date and time changes and receiving method changes, and
notifies the respective delivery centers of contents of received change requests.
